(19) United States
(12) Patent Application Publication
(10) Pub. No.: US 2008/0165183 A1
(43) Pub. Date: Jul. 10, 2008

(54) System and Method for Three-Dimensional Display of Airspaces

(76) Inventors: Theodore C. Rassieur, Long Beach, CA (US); Todd M. Acker, Long Beach, CA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/936,231

(22) Filed: Nov. 7, 2007

Related U.S. Application Data
(60) Provisional application No. 60/864,866, filed on Nov. 8, 2006.

(51) Int. Cl. G06T 15/00

(52) U.S. Cl. 345/419

(57) ABSTRACT

A system and method for representing an instance of airspace is disclosed. The system includes a two-dimensional aeronautical chart and a three-dimensional model. The aeronautical chart provides information representing the dimensions of an instance of airspace (e.g., the size and shape of a class of airspace). The model translates the information provided by the aeronautical chart into a three dimensional tool that enables a user to readily envision the airspace parameters define by the chart. The model may have a unitary structure or include a plurality of pieces, each piece defining an altitude block. The pieces may be reconfigurable, and may be selectively coupled to create a series of continuous altitude blocks that define an instance of airspace. With this configuration, exact, three-dimensional navigational representations of airspace are provided.

### CROSS REFERENCE TO RELATED APPLICATIONS

This application claims priority to provisional application No. 60/864,866, entitled “System and Method for Three-Dimensional Display of Airspaces” and filed 8 Nov. 2006. The disclosure of the provisional application is hereby incorporated by reference in its entirety.

### FIELD OF THE INVENTION

The present invention relates to an instructional aid for pilots and, more specifically, to a system and method for representing the different types of airspace in three dimensions used in conjunction with aeronautical maps.

### BACKGROUND

The world's navigable airspace is divided into three-dimensional segments, each of which is assigned to a specific airspace class (e.g., Class A, Class B, Class C, Class E, and Class G). For example, Class A airspace is applied to all airspace between 18,000 feet mean sea level (MSL) and 60,000 feet (also called Flight Level (FL) 600). Class B airspace, typically used around major airports, has a funnel shape designed to contain arriving and departing commercial air traffic operating under instrument flight rules (IFR). Class B airspace typically constitutes the airspace from ground surface to 10,000 feet MSL. Class G airspace, which is uncontrolled, is mostly used for a small layer of airspace near the ground (e.g., from the surface to 700 feet above ground level (AGL) or from the surface to 1,200 feet AGL). Each airspace class includes varying operational parameters defined by the Federal Aeronautics Association (FAA) (e.g., IFR Requirements, VFR Requirements, etc.). Exemplary FAA-designated airspace classes are illustrated in FIG. 1.

Each instance of airspace class is individually tailored (shaped and sized) to meet the needs of a specific location (e.g., degree of traffic, arrival/departure routes, terrain, and adjacent airspace instances). Consequently, any given instance of airspace may have a complex, unique shape including a series of continuous altitude layers or blocks (regions of space that have a different top and or bottom altitude than its neighbors) that must be navigated by pilots entering and leaving the area. Pilots must plan flights taking into account the location and dimension of each altitude block.

Pilots, then, are responsible for knowing during a flight what their horizontal and vertical position is relative to the airspace and, accordingly, observe appropriate rules of flight. Since airspace includes complex, overlapping shapes, it can be challenging for a pilot to plan or conduct a flight with respect to the different types of airspace without violating airspace rules. Traditionally, two dimensional aeronautical charts have been used by pilots to navigate airspace. For example, United States FAA aeronautical charts show information about size, shape, and location of the different types of airspace in the national airspace system. The lateral boundaries are drawn on the chart with lines, and the upper and lower altitude of the altitude blocks are typically denoted with text and/or numbers. These charts are dense with information, making it difficult for a pilot to interpret a given airspace to successfully navigate through a particular airspace.

Thus, it would be desirable to provide site-specific, three-dimensional (3-D) models of airspaces to aid pilots in navigating class instances.

### SUMMARY OF THE INVENTION

The present invention provides a system and method for representing an instance of airspace in three dimensions. The system includes a two-dimensional aeronautical chart and a three-dimensional model or tool. The aeronautical chart provides information representing the dimensions of an instance of airspace (e.g., the size and shape of a class of airspace). The model translates the information provided by the aeronautical chart into a three dimensional tool. That is, the model may have dimensions corresponding to the information provided by the chart. The model may have a unitary structure or include a plurality of pieces, each piece defining an altitude block/layer. The pieces may be reconfigurable, and may be selectively coupled to create a series of continuous altitude blocks/layers that collectively define an instance of airspace. With this configuration, exact, three-dimensional navigational representations of airspace are provided.

### BRIEF DESCRIPTION OF THE DRAWINGS

FIG. 1 illustrates a schematic diagram of exemplary airspace classes.

FIG. 2 illustrates a top view of an aeronautical chart generally depicting the airspace around an airport.

FIG. 3 illustrates a front perspective view of a three-dimensional model in accordance with an embodiment of the present invention, wherein the model represents the airspace around the airport shown in the chart of FIG. 2.

FIGS. 4 and 5 illustrate the chart of FIG. 2 with the model of FIG. 3 placed thereon, showing the interaction of the model with the chart.

FIG. 6 illustrates an exploded view of a model in accordance with another embodiment of the invention.

FIGS. 7A and 7B illustrate reorientation of the model of FIG. 6 from a first configuration (FIG. 7A) to a second configuration (FIG. 7B).

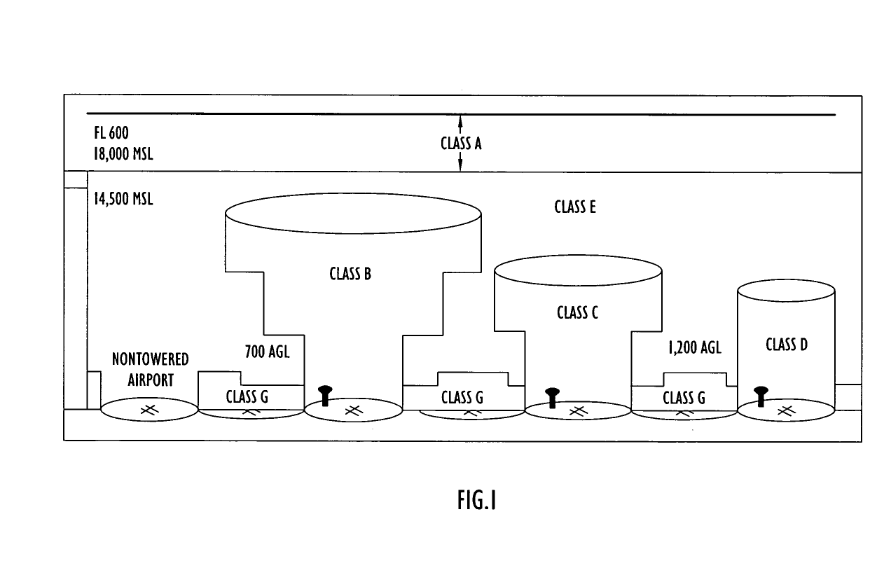

Like reference numerals have been used to identify like elements throughout this disclosure.

### DETAILED DESCRIPTION OF THE INVENTION

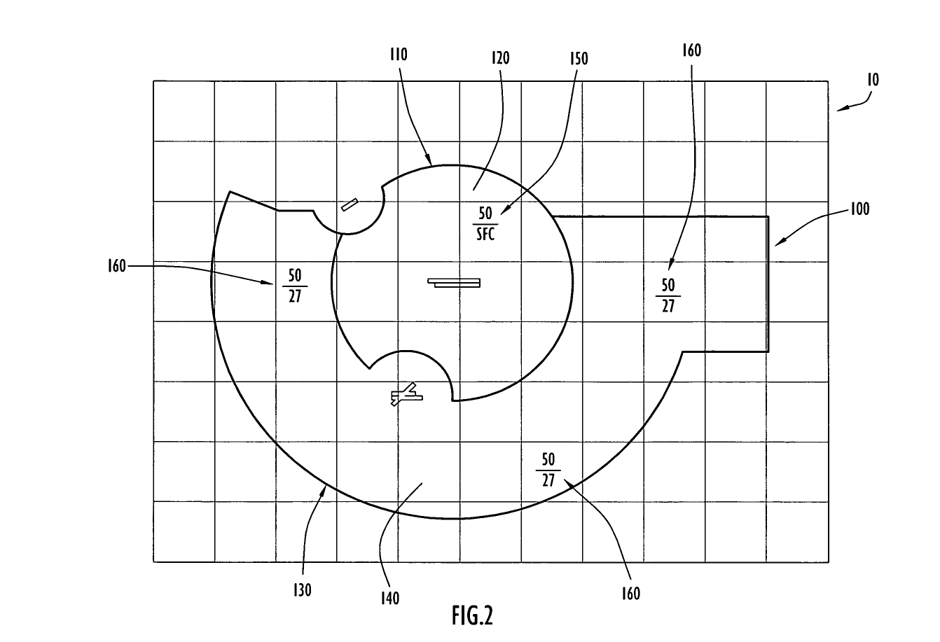

FIG. 2 shows a two-dimensional aeronautical chart or map 10 describing an instance of airspace 100. The instance of airspace 100 may include a class of airspace (e.g., Class A airspace, Class C airspace, Class E airspace, etc.), and/or restricted flight areas. For example, the embodiment of FIG. 2 illustrates Class C airspace above the airport located in Ontario, Calif.

Each instance of airspace 100 may be divided into a plurality of continuous altitude segments or blocks (also called layers), each segment having a defined perimeter. Thus, the chart 10 includes information defining the boundaries of the instance of airspace 100. Specifically, the chart 10 includes indicia that must be interpreted to define an instance of airspace 100. As shown in FIG. 2, boundary lines define the lateral dimensions of the instance of airspace 100, as well as the altitude segments. A first boundary line 110 defines the perimeter of a first altitude segment 120 and a second boundary line 130 defines the perimeter of a second altitude segment 140. Thus, in reading the chart 10, the lateral dimensions of an altitude segment 120, 140 are provided by its associated boundary line 110, 130 (as interpreted by a predetermined scale). On the chart 10, the boundary lines 110, 130 may be further identified utilizing line color and line character (e.g., solid magenta for lines Class C airspace, dashed magenta lines for Class E airspace, solid blue lines for Class B airspace, and dashed blue lines for Class D airspace).

Information relating to the vertical boundaries of the altitude segments 120, 140 may also be provided by indicia. Specifically, the chart 10 may include codes that identify the floor and ceiling altitudes encompassing the altitude segment 120, 140. In the embodiment illustrated in FIG. 2, a first code 150 identifies the ceiling (uppermost) and floor (bottommost) altitudes of the first altitude segment 120. The first code 150 (50/SFC) designates that the ceiling of the first altitude segment 120 is 5,000 feet MSL and the floor of the first altitude segment is the ground surface. Similarly, a second code 160 specifies the vertical boundaries of the second altitude segment 140. Thus, the designation 50/27 specifies the ceiling of the second altitude segment 140 is 5000 feet MSL, while the floor is 2700 feet MSL. Together, the first and second codes 150, 160, along with the lateral boundary lines 110, 130, define an instance of airspace in the chart 10.

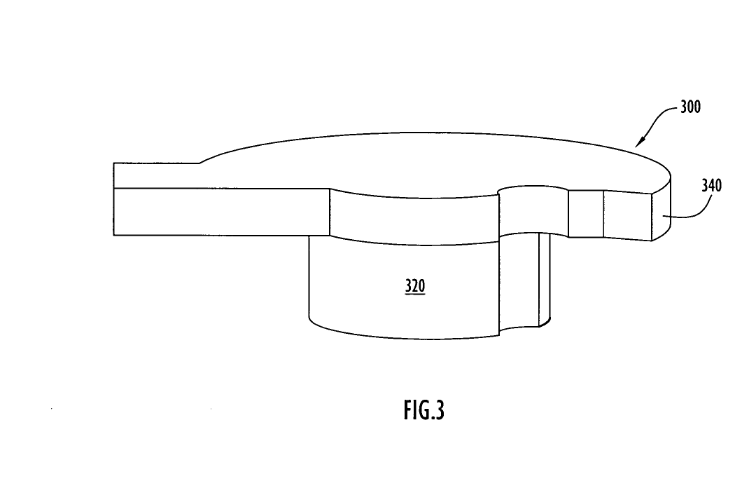

Thus, the indicia attempt to describe a three-dimensional airspace utilizing a two-dimensional chart configuration. A reader of the chart 10, however, may not readily visualize the perimeter of the altitude blocks 120, 140 and/or the dimensions of the instance of airspace 100. The present system further includes a three-dimensional model to accurately represent the perimeter of the airspace 100 as defined by the indicia on the chart 10. FIG. 3 shows an isolated, perspective view of a three-dimensional airspace model or tool 300 in accordance with the present invention. The model 300 may include portions corresponding to the various altitude segments, such as the altitude segments 120, 140 depicted on the chart 10. In the illustrated embodiment, the model 300 includes a first portion 320 and a second portion 340. The first portion 320 correlates to the first altitude segment 120 (e.g., the altitude segment immediately over the airport), while the second portion 340 correlates to the second altitude segment 140 (i.e., the altitude segment continuous with the first altitude segment 120). In other words, the first portion 320 of the model 300 may provide a physical representation of the first altitude segment 120, with lateral dimensions defined by the first boundary line 110 and the ceiling/floor boundaries defined by the information provided by the first code 150. Similarly, the second portion 340 of the model 300 may form a three-dimensional representation of the second altitude block 140, having lateral dimensions corresponding to the second boundary line 130 and upper/lower heights defined by the information provided in the second code 160. For example, in FIG. 3, the first 320 and second 340 model portions generally depict Class C airspace.

A predetermined measurement scale may provide the overall dimensions of the model 300. Typically, the scale corresponds to the scale of the chart 10. For example, the chart 10 may define ½ inch as representing 1000 lateral feet. Consequently, the model 300 may be created utilizing a similar scale, with both lateral and vertical scales being defined as ½ per 1000 vertical feet. It is important to note that other measurement scales may be utilized.

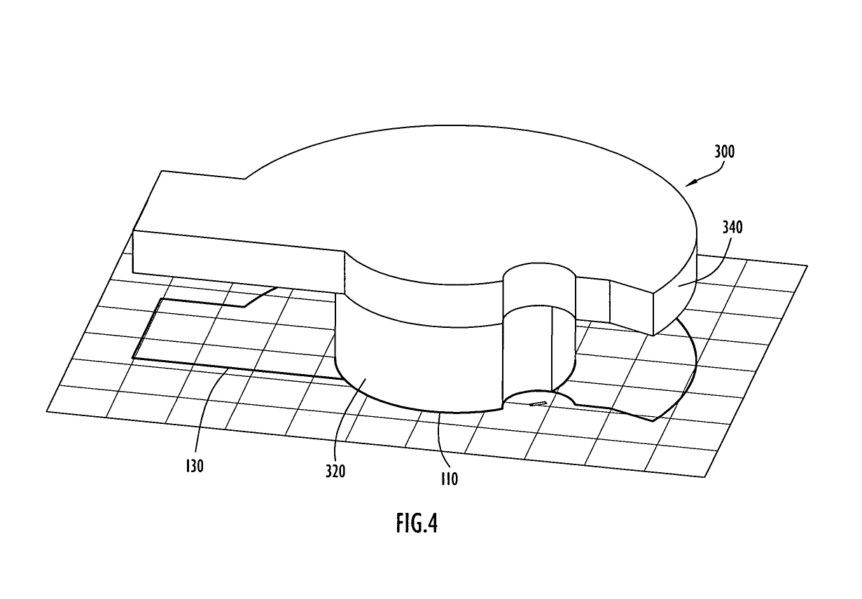

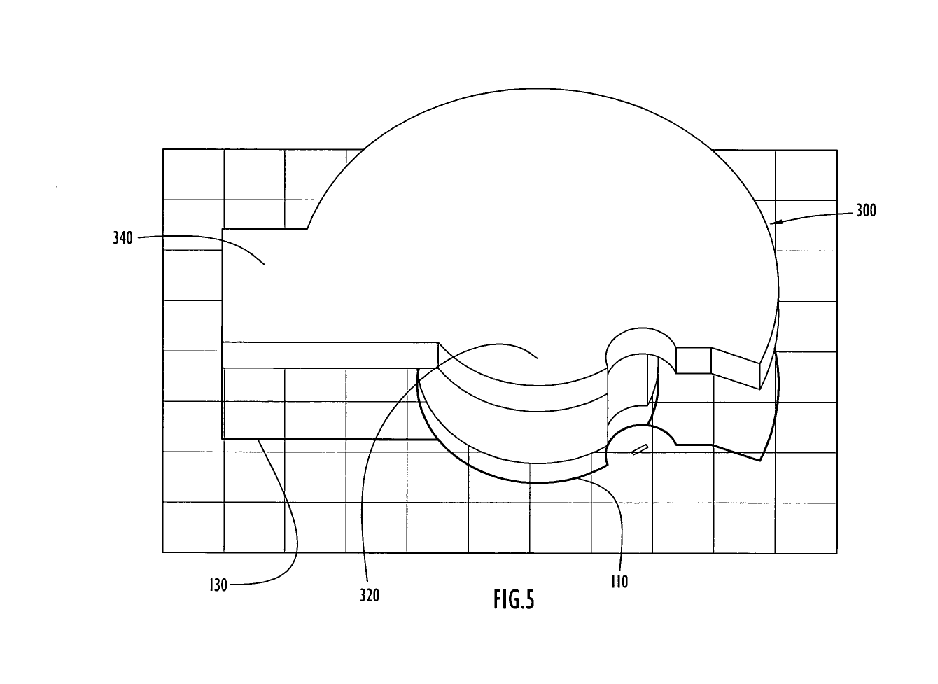

Referring to FIGS. 4 and 5, in operation, a user orients the model 300 onto the chart 10, aligning the model such that it matches the perimeter of the instance of airspace 100. The basis (the lowest portion) of the model 300 of the model contacts the chart 10, with the first portion 320 oriented within the first boundary line 110 of the first altitude segment 120, and the second portion 340 oriented such that it aligns with the second boundary line 130 of the second altitude segment 140.

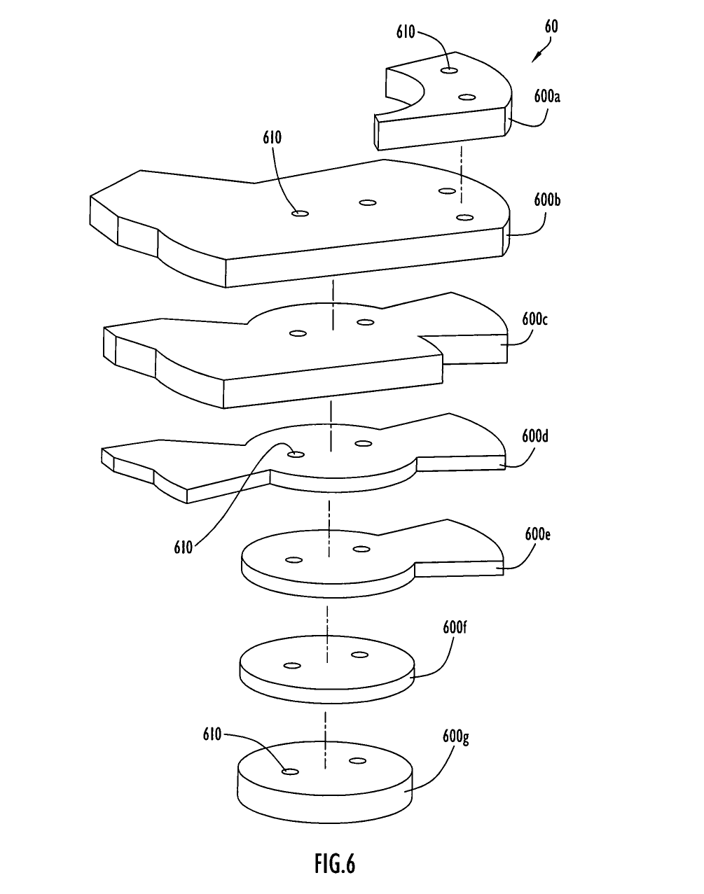

The model 300 may possess a unitary structure; alternatively, the portions forming the model may be separable to enable selective reconfiguration. FIG. 6 shows an exploded view of a three-dimensional airspace model in accordance with another embodiment of the invention. As illustrated, the airspace model 600 includes a plurality of portions 600A, 600B, 600C, 600D, 600E, 600F, 600G. Each portion 600A-600G may be sized and shaped to correspond with an altitude segment/layer. The model portions 600A-600G may couple to each other via a fastener. By way of specific example, each model portion 600A-600F may include one or more magnet fasteners 610 configured to connect to each other. Aligning the fasteners on adjoining model portions connects the portions, securing them together. Alternatively, the model portions 600A-600G may include dowels formed into the top surface of the portion that mate with bores formed into the bottom surface of the portion. Other fastening mechanisms may also be utilized.

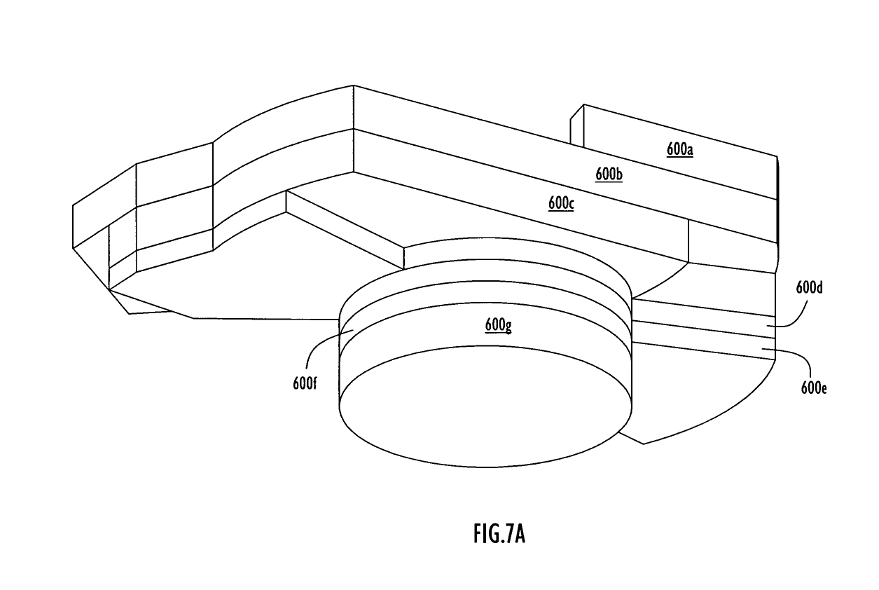

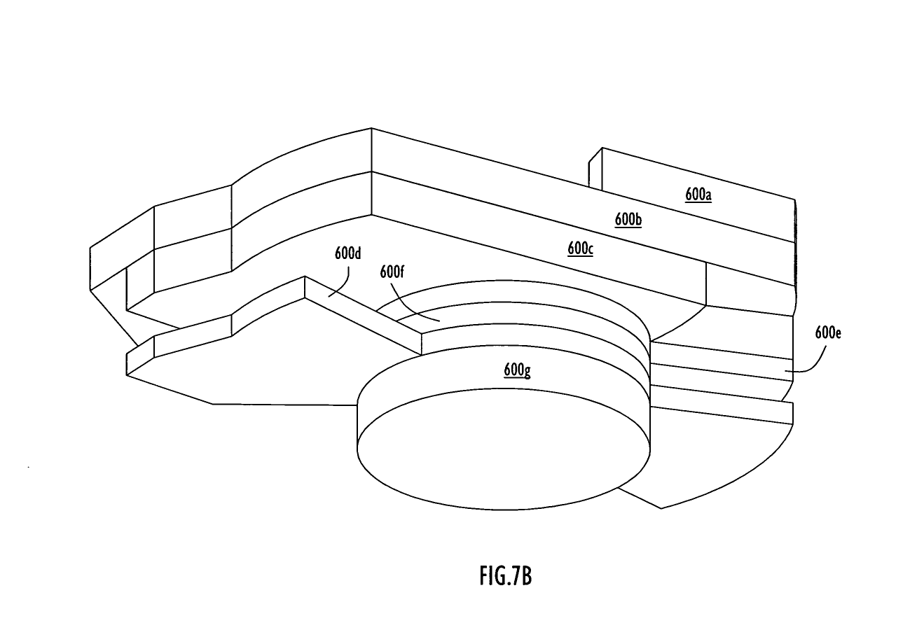

With this configuration, the various model portions are reconfigurable to create a variety of airspace instances as depicted on an aeronautical chart 10. Thus, the model portions may be reconfigured from a first orientation (FIG. 7A) to a second orientation (FIG. 7B) by adding, omitting, or rearranging the model portions 600A-600G as required by the chart indicia. In this manner, the portions forming the model 300 may be reconfigured to adapt the model pieces for a given instance of airspace (i.e., to tailor the model 300 to the airspace as defined by the chart). In addition, the pieces may be gradually peeled away or added to illustrate the various airspace layers forming an instance of airspace 10.

The inventive system provides a teaching and visualization tool for pilots and flying enthusiasts. The three-dimensional model makes the physicality of the National Airspace System easier to understand and easier to navigate since the models are configured to generally represent the true dimensions that they occupy in the atmosphere. The models, moreover, may be sized to be positioned over the lateral dimensions depicted on various aeronautical charts; consequently, the models allow a pilot to better see the lateral boundaries, enabling the pilot to visualize the actual dimensional depth that the airspace occupies. This will aid in understanding how the airspace system works.

Thus, the present invention physically represents airspaces in a manner that is useful with FAA published aeronautical maps. The present invention provides a three-dimensional representation of each block of airspace as it appears in relation to topography and the atmosphere, giving a pilot a true perspective of the volume of space that the airspace occupies. The system essentially displays the exact dimensions of each layer of airspace (in relation to existing aeronautical data) to aid a pilot in navigational planning and awareness. This enables pilots to cross reference known data and be able to visualize exactly where it is that the airspace exists.

While the present invention has been described in detail and with reference to specific embodiments thereof, it will be apparent to one skilled in the art that various changes and modifications can be made therein without departing from the spirit and scope thereof. For example, the chart 10 may comprise any aeronautical chart or map providing information relating to airspace boundaries and/or airspace classes including, but not limited to, restricted flight zones, special use airspace, transition routes (VFR/IFR flyways and/or corridors), etc. The model 300 may be formed from any suitable material. By way of example, the model 300 may be formed from transparent, translucent, colored, or opaque materials. By way of specific example, the model 300 may be formed from transparent plastic such as polymethyl methacrylate, polystyrene, and polycarbonate. In addition, the model portions 600A-600G may be formed from the same or different materials, or possess the same or different physical properties. For example, the basis of the model 300 (i.e., the lowest part of the model in contact with the chart) may be constructed of a transparent material, while the upper model portions may be formed from opaque materials. The model 300, furthermore, may be colored coded to match with the color-coding used on the aeronautical charts. Thus, the model may possess a magenta color to indicate Class C airspace when indicated as magenta on the chart 10.

The model 300 may possess any suitable dimensions (e.g., size and shape). Typically, the lateral boundaries will possess substantially similar dimensions as those represented on the aeronautical chart 10 so that the model can be placed directly on the chart, enabling a pilot to see exactly where the airspace 100 exists and showing the relationship of the airspace instance 100 with the ground. The measurement scale utilized in forming the models may be any suitable for its described purpose. The vertical dimensions of the airspace models may be varied for each different type of aeronautical chart 10.

In addition to corresponding to instance of airspace 100 provided by the chart 10, the model 300 may also represent any category of airspace. Thus, the model 300 may be configured to represent any instance of airspace including, but not limited to, airspace classes, transition routes, etc. By way of example, the model may be configured to represent Class A, Class, B, Class, C, Class, E, and Class F airspaces, layers of these classes or airspace, or any other airspace instances (including those defined by the FAA). Each individual model portion 600A-600G, moreover, may represent a Class of airspace. For example, the first model portion 320 may represent one class of airspace (e.g., Class G), while the second model portion 340 may represent another class of airspace (e.g., class B). This enables the connection of multiple, adjacent airspace classes to be shown by the model 300. The model 300, moreover, may include additional portions to define further instances of airspace class 100. The number of portions forming each model, moreover, is not limited.

The model 300 may possess a unitary structure or may be formed utilizing a plurality of interconnecting pieces. By way of example, the model 300 may include multiple pieces coupled together by stacking. Alternately or in addition to, the model 300 may be formed from multiple pieces connected together via a fastener such as hook and loop fasteners, magnets, etc. The fasteners may be disposed on any suitable location. Instead of having top and/or bottom surfaces couple, the model portions 600A-600G may couple in a side-by side relationship.

Thus, it is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

We claim:

1. A system for three dimensional representation of airspace comprising:
an aeronautical chart including at least one indicium defining a characteristic of a class of airspace; and
a three-dimensional airspace model device having at least one dimension corresponding to the indicium on the aeronautical chart,
wherein the model is selectively oriented on the aeronautical chart to provide a three-dimensional representation of the class of airspace.

2. The system of claim 1, wherein:
the at least one indicium includes indicia relating to a lateral boundary value of the class of airspace and a vertical boundary value of the class of airspace; and
the at least one dimension includes dimensions corresponding the lateral boundary value or the vertical boundary value.

3. The system of claim 1, wherein:
the aeronautical chart includes:
a first indicium defining a first altitude segment, and
a second indicium defining a second altitude segment; and
the three-dimensional airspace model comprises:
a first model portion defining the first altitude segment including scaled dimensions corresponding to the first indicium on the aeronautical chart, and
a second model portion defining the second altitude block including scaled dimensions corresponding to the second indicium on the aeronautical chart,
wherein the first model portion couples to the second model portion.

4. The system of claim 3, wherein the dimensions of the first altitude segment differ from the dimensions of the second altitude segment.

5. The system of claim 3, wherein each of the first model portion and the second model portion includes a fastener operable to connect the first model portion to the second model portion, and vice versa.

6. The system of claim 5, wherein the fastener comprises one or more magnets.

7. The system of claim 3, wherein:
the aeronautical chart includes a third indicium defining a third altitude segment; and
the model further comprises a third model portion defining the third altitude segment depicted on the chart, wherein the third model portion is interchangeable with each the first and second model portions.

8. A method of representing a class of airspace comprising:
(a) providing two-dimensional aeronautical chart including indicia defining a class of airspace;
(b) providing a three-dimensional tool having dimensions corresponding to the chart indicia to define a three-dimensional representation of the class of airspace; and
(c) positioning the tool on chart.

9. The method of claim 8, wherein:
the indicia defines a lateral boundary value of the class of airspace and a vertical boundary value of the class of airspace; and
the tool dimensions correspond to both the lateral and vertical boundary values.

10. The method of claim 8, wherein:
the aeronautical chart includes:
a first indicium defining a first altitude segment, and
a second indicium defining a second altitude segment;
the three-dimensional tool comprises:
a first tool portion defining the first altitude segment, the tool including scaled dimensions corresponding to the first indicium on the aeronautical chart, and
a second tool portion defining the second altitude block segment, the tool including scaled dimensions corresponding to the second indicium on the aeronautical chart;
(b) comprises (b.1) coupling the first tool portion to the second tool portion; and
(c) comprises (c.1) contacting the first tool portion to the aeronautical chart.

11. An airspace model device comprising:
a first model portion representing a first altitude segment of a class of airspace; and
a second model portion representing a second altitude segment of the class of airspace,
wherein the first portion is selectively reconfigurable from a first model configuration to a second model configuration.

12. The airspace model device of claim 11, wherein:
the first model portion includes a first fastener component;
the second model portion includes a second fastener component; and
the first fastener component mates with the second fastener component.

13. The airspace model device of claim 12, wherein the fastener components comprise a magnet.

14. The airspace model device of claim 11, wherein the wherein the model device is selectively orientable on an aeronautical chart to provide a three-dimensional representation of the class of airspace.

15. The airspace model device of claim 14, wherein the dimensions of the model device generally correspond to indicia provided on the aeronautical chart.
